(19) United States
(12) Patent Application Publication
(10) Pub. No.: US 2009/0066970 A1
(43) Pub. Date: Mar. 12, 2009

(54) Arrangement and method for improving the measurement accuracy in the nm range for optical systems

(75) Inventors: Gerd Scheuring, Muenchen (DE); Hans-Artur Boesser, Breidenbach (DE); Wolfgang Sulik, Asslar (DE); Michael Heiden, Woelfersheim (DE); Walter Steinberg, Weilmuenster-Moettnau (DE)

Correspondence Address: Davidson, Davidson & Kappel, LLC, 485 7th Avenue, 14th Floor, New York, NY, 10018, US

(73) Assignees: MueTec Automatisierte Mikroskopie und Messtechnik GmbH, Muenchen (DE); VISTEC Semiconductor Systems GmbH, Weilburg (DE)

(21) Appl. No.: 12/154,051

(22) Filed: May 20, 2008

(30) Foreign Application Priority Data
May 21, 2007 (DE) DE 102007023796.2

(51) Int. Cl. G01B 11/02

(52) U.S. Cl. 356/625

(57) ABSTRACT

A method and a device for improving the measurement accuracy in the nm range for optical systems are disclosed. The object is provided with a plurality of structures oriented in the X and Y-coordinate direction. The light beam coming from at least one light source defines an optical illumination path.

This claims the benefit of German Patent Application No. DE 10 2007 023 796.2, filed on May 21, 2007 and hereby incorporated by reference herein.

The present invention relates to an arrangement for improving the measurement accuracy in the nm range for optical systems. The object to be examined with the optical system includes a plurality of structures. The object is illuminated with at least one light source arranged in the optical illumination path. At least one detector mounted in an optical detection path detects the light coming from the object. At least one optical means changing the polarization properties and one optical means causing a beam offset and/or at least one optical means changing the polarization property and/or at least one optical means causing a beam offset is arranged in the optical detection path and/or in the optical illumination path. A measurement window is stationarily associated with a structure. The measurement window for the structure may be oriented in any orientation with respect to the X and Y-coordinate direction.

The invention further relates to a method for improving the measurement accuracy in the nm range for optical systems. In particular, a plurality of structures is applied to an object, and the object is illuminated with at least one light source arranged in the optical illumination path. An image of the structure is acquired by at least one detector mounted in an optical detection path.

### BACKGROUND

The prior art devices have been found to yield different results when measuring the same structure after it has been rotated, the same area of the structure being measured. Preferably, the structure is rotated by 90° around the Z-coordinate direction, causing different results for these different orientations. The reason for these different results is that the mirrors and splitters used in the optical path effect a polarization. In addition, each splitter causes a beam offset also bringing about an asymmetry with respect to the measured values in the X-coordinate direction and in the Y-coordinate direction depending on the sample orientation. Both effects combined cause the measurements of the structures in the X-coordinate direction and in the Y-coordinate direction for the same structures to exhibit a difference, which additionally also depends on the structure size. This logically results in reduced unambiguousness of the measurement results.

### SUMMARY OF THE INVENTION

An object of the present invention is to provide a device with which the unambiguousness of the measurement results for the same structure with different orientations is improved.

This object may be achieved by an arrangement for improving the measurement accuracy in the nm range for optical systems.

It is further an alternate or additional object of the present invention to provide a method with which reproducible and unambiguous measurement results may be achieved for the same structure with different orientations.

This object may be achieved by a method for improving the measurement accuracy in the nm range for an optical system. A plurality of structures is provided on an object. The optical system has at least one light source arranged in an optical illumination path and least one detector mounted in an optical detection path.

The inventive arrangement for improving the measurement accuracy in the nm range for optical systems with which a plurality of structures is applied to an object is particularly advantageous. The at least one structure may be illuminated with at least one light source arranged in the optical illumination path. At least one detector is mounted in the optical detection path for detection. At least one optical means changing the polarization properties and one optical means causing a beam offset and/or at least one optical means changing the polarization property and/or at least one optical means causing a beam offset is arranged in the optical detection path and/or in the optical illumination path. A measurement window is stationarily associated with a structure to be measured, wherein the measurement window is oriented in a defined orientation with respect to the structure. There are further provided means minimizing the differences in the measurements of the structures by the detector for different orientations of structure and measurement window.

The different orientations are orthogonal. The different orientations are oriented in the X-coordinate direction and Y-coordinate direction. The optical means may be designed as a beam splitter or as a mirror or as a filter.

The means may be designed as a unit removing the optical means changing the polarization property from the optical axis for the measurement. The means is a further optical means changing the polarization property, which compensates a change of the polarization property caused by the optical means.

The means may be a further optical means changing the beam offset, which compensates a beam offset caused by the optical means.

The means may be a further optical means changing the polarization property and an optical means changing the beam offset, which compensates a change of the polarization property caused by the optical means and the beam offset. The mirrors and beam splitters present in the arrangement are rotated by 45° with respect to the orientation of the structures on the substrate.

The means may be a unit offsetting the objective or at least one tube lens parallel to the optical axis in the plane created by the X-coordinate direction and the Y-coordinate direction such that the beam offset caused by the splitter with respect to the optical axis is compensated.

The means may be a unit offsetting a tube lens or an objective parallel to the optical axis in the plane created by the X-coordinate direction and the Y-coordinate direction such that the beam offset caused by the splitter with respect to the optical axis is compensated.

The mirrors and beam splitters present in the arrangement are rotated by 45° with respect to the orientation of the structures on the substrate.

The optical means used, such as mirrors, filters or splitters, have little influence on the polarization properties, wherein the transmissions of s-polarized and p-polarized light differ by less than 15%.

The optics used in the optical illumination path and/or in the optical detection path can be designed such that the intensities of the s-polarized and p-polarized illumination light differ by less than 15%.

The inventive method for improving the measurement accuracy in the nm range for optical systems for examining a plurality of structures applied to an object may include at least one light source in the optical illumination path. At least one detector can be mounted in the optical detection path. At least one optical means changing the polarization properties and one optical means causing a beam offset and/or at least one optical means changing the polarization property and/or at least one optical means causing a beam offset can be provided in the optical detection path and/or optical illumination path. A measurement window can be stationarily associated with a structure. There further may be provided means so that the differences in the measurements of the structures by the detector for different orientations of structure and measurement window are minimized.

### BRIEF DESCRIPTION OF THE DRAWINGS

In the following, embodiments will explain the invention and its advantages in more detail based on the accompanying figures, in which:

FIG. 1 schematically shows an arrangement for incident and transmitted light, wherein the inventive arrangement may advantageously be used for position measurements, structure width measurements and for measuring overlay data;

FIG. 2 shows a schematic representation of the beam offset caused by a beam splitter with respect to the optical axis;

FIG. 3 shows a schematic representation of the structures arranged in the X-coordinate direction and the Y-coordinate direction on the substrate;

FIG. 4 shows a schematic representation of a dichroic beam splitter used in the optical path of the arrangement;

FIG. 5 shows a plot of the difference in the CD measurement results of a structure measured in the X-coordinate direction and, rotated by 90°, in the Y-coordinate direction as a function of the structure size;

FIG. 6 shows a plot of the CD measurement results of a structure measured in the X-coordinate direction and, rotated by 90°, in the Y-coordinate direction as a function of the structure size, wherein two crossed splitter mirrors are located in the optical path of the arrangement; and

FIG. 7 shows a plot of the measurement results of a structure measured in the X-coordinate direction and, rotated by 90°, in the Y-coordinate direction as a function of the structure size, wherein there are two splitter mirrors in antiparallel positions in the optical path of the arrangement, and the objective is displaced by 450 μm.

### DETAILED DESCRIPTION

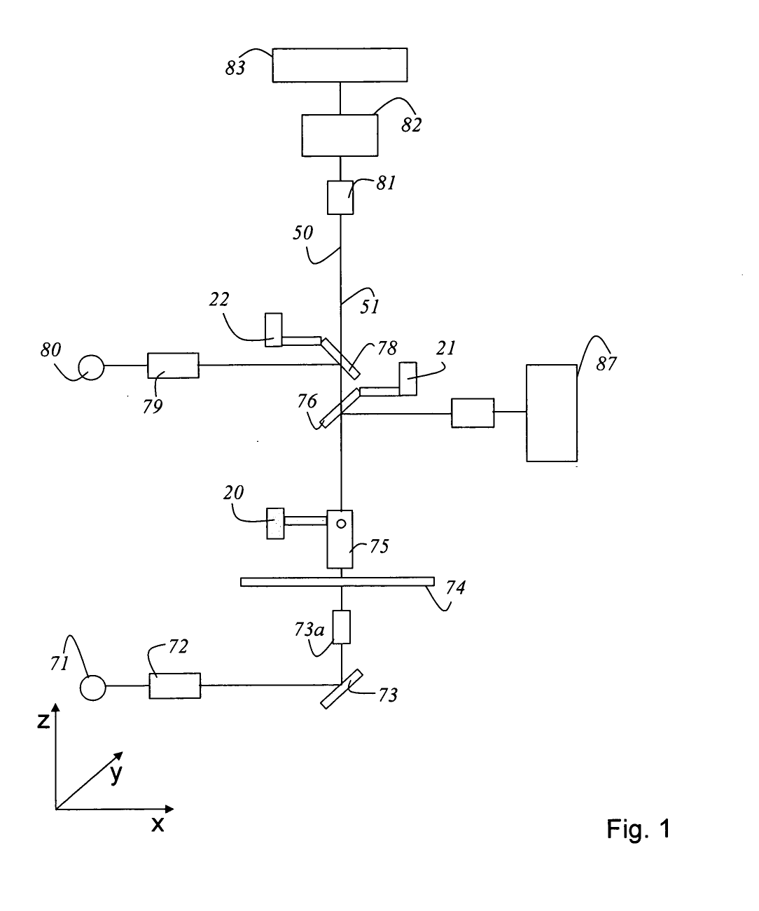

FIG. 1 schematically shows an arrangement for incident and transmitted light, as used in a CD measuring instrument or analogous measuring devices. The arrangement also includes a transmitted light illumination means 71 directing the light, via a collector 72, to a deflecting mirror 73, which directs the light, via a condenser 73a, to a substrate 74 bearing the various structures. There is further provided an incident light illumination means 80 also launching the light, via an incident light collector 79, into the optical axis 51 and/or the optical detection path 50 of the optical system by means of an incident light launching mirror 78. Above the substrate 74, there is provided an objective 75 imaging the light of the incident light illumination means 80 onto the substrate and collecting the light from the transmitted light illumination means 71, and/or also collecting the light of the incident light illumination means coming from the substrate 74 and finally imaging it onto a detector 83, which may be designed as a camera, scanner or line scanner. The optical system is further provided with a focus system 87 whose measurement light is also launched into the optical axis 51 of the optical system via a splitter mirror 76. The incident and/or transmitted light collected by the objective 75 travels through the various beam splitters in the optical illumination path and reaches the detector 83 via tube lens optics 81 and additional optics 82, if necessary.

Several elements of the optical system are each provided with a movement means. A first movement means 20 associated with the objective 75 may be used to offset the objective 75 a predetermined distance parallel to the optical axis. Likewise, the splitter mirror 76 is associated with a second movement means 21, with which the splitter mirror 76 may be pivoted out of the optical path. The incident light launching mirror 78 is associated with a third movement means 22, with which the incident light launching mirror 78 may also be pivoted out of the optical path.

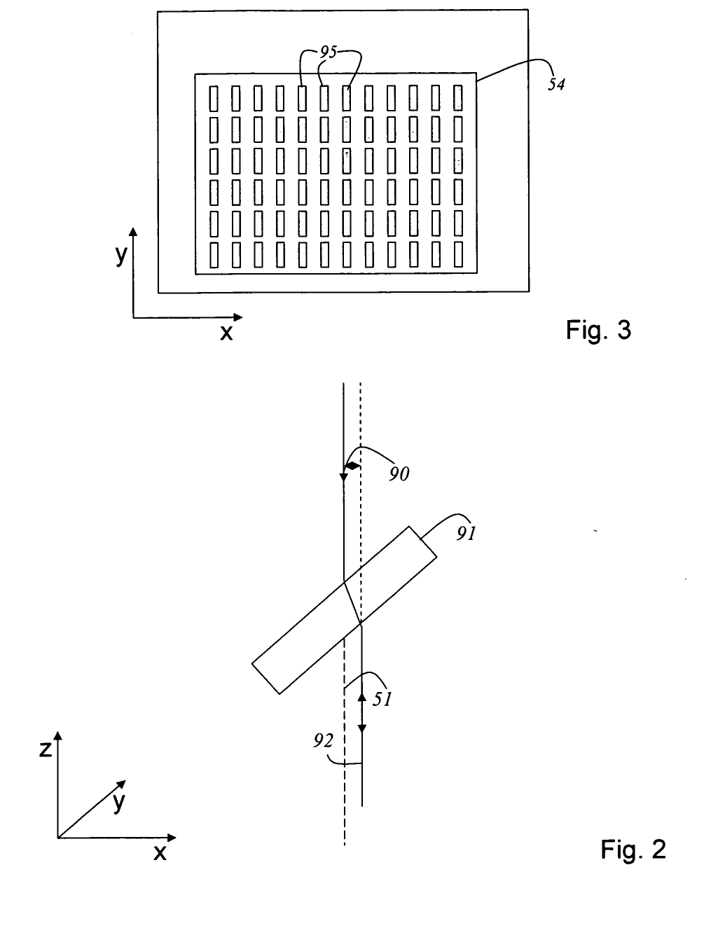

FIG. 2 schematically shows a beam offset 90 as caused by a beam splitter. The light beam originally travels in the optical axis 51 before reaching the beam splitter 91. A beam offset 90 is caused by the beam splitter 91. In the illustration shown, the beam offset was caused in the X-coordinate direction. With another arrangement of the beam splitter 91, it is also possible to effect a beam offset in the Y-coordinate direction. The beam offset may also occur in any direction in the plane created by the X-coordinate direction and the Y-coordinate direction.

FIG. 3 schematically shows an arrangement of structures 95 on the substrate 54. As clearly shown in FIG. 5, the structures 95 are oriented in the X-coordinate direction and in the Y-coordinate direction.

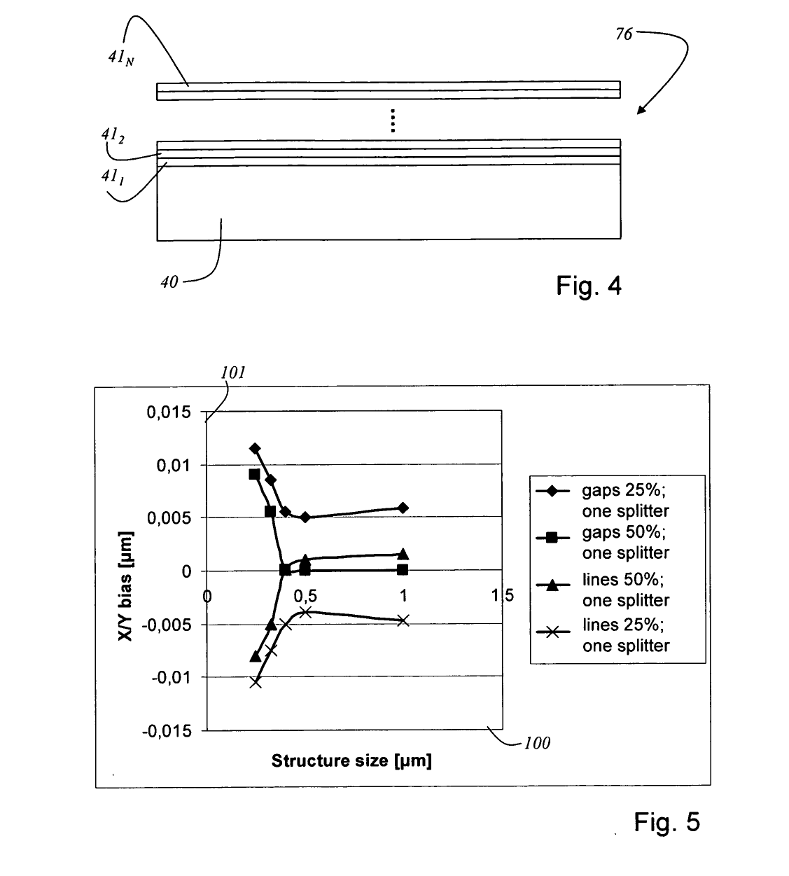

FIG. 4 shows a schematic representation of a dichroic beam splitter 76 used in the optical path of the arrangement. The beam splitter 76 essentially consists of a transparent substrate 40 to which there are applied a plurality of thin layers 41₁, 41₂, . . . , 41_{N} selected such that a separation for the selected wavelengths is achieved. In the illustration shown, the beam splitter 76 directs the measurement light of the focus system 87 into the optical path of the optical system. The wavelength of the focus system is 903 nm.

FIG. 5 shows a plot of the CD measurement results of a structure measured in the X-coordinate direction and, rotated by 90°, in the Y-coordinate direction as a function of the structure size. The structure size is plotted on the abscissa 100, and the difference of the measured structure widths in the two orientations is plotted on the ordinate 101. This difference is referred to as X/Y bias. The evaluation of the measurements was performed with various threshold values, namely with a threshold value of 25% and with a threshold value of 50%. The threshold value of 100% stands for the maximum, and 0% stands for the minimum of the respective profile height. With a threshold value of 25%, the difference of the measured values for the measured structure size is significantly larger than with a threshold value of 50%. This means that the measured profile must be unsymmetrical.

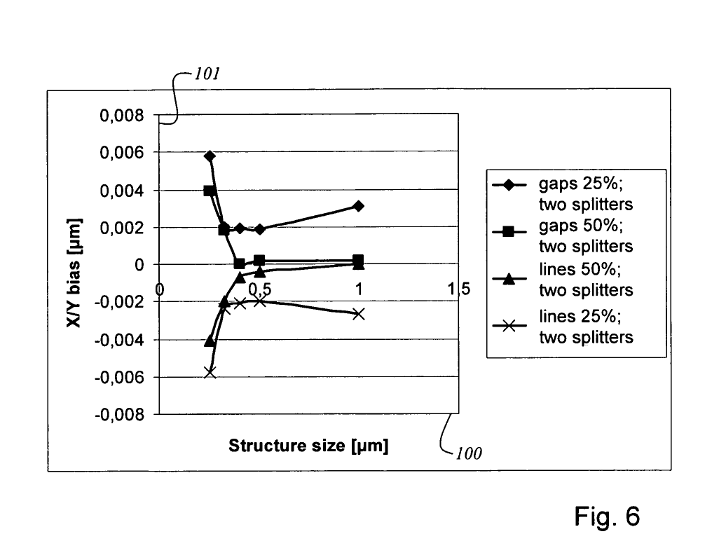

FIG. 6 shows a plot of the CD measurement results of a structure measured in the X-coordinate direction and, rotated by 90°, in the Y-coordinate direction as a function of the structure size. There were two crossed splitter mirrors in the optical path. Again, the structure size is plotted on the abscissa 100. The X/Y bias (0°/90° deviation of the measured value) is again plotted on the ordinate 101. The measurements were conducted with the same threshold values as in the measurement illustrated in FIG. 5. As can be seen from the illustration of FIG. 6, the two crossed splitters result in a significant improvement of the deviation of the measured values in the X-coordinate direction and in the Y-coordinate direction. This improvement is due to the fact that the polarization effect caused by the splitter is approximately cancelled depending on the orientation of the structures on the substrate 54.

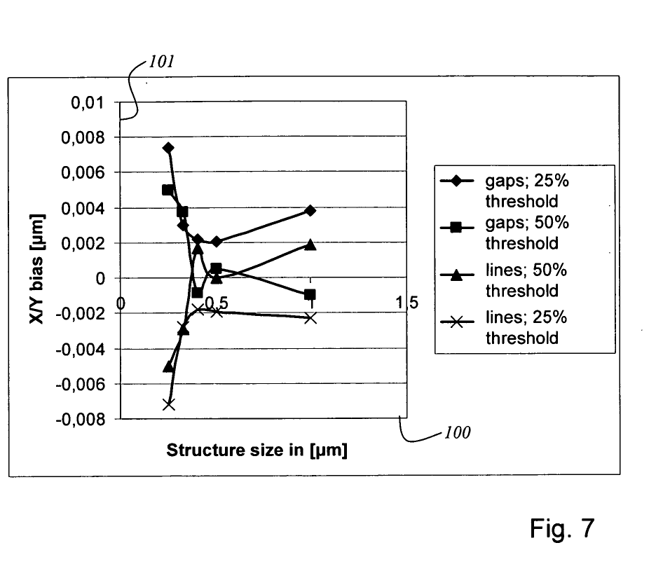

Since, as mentioned above, a splitter represents only a plane-parallel plate, it causes an axis offset with respect to the optical axis. The extent of the axis offset depends on the thickness of the beam splitter. When evaluating the deviation of the measurement results towards a smaller structure size, this axis offset must also be taken into account. FIG. 7 shows a plot of the CD measurement results of a structure measured in the X-coordinate direction and, rotated by 90°, in the Y-coordinate direction as a function of the structure size. Two splitter mirrors are arranged in antiparallel positions in the optical path. In addition, the objective is displaced by 450 μm. The shift of the objective was performed in the Y-coordinate direction. The structure size is also plotted on the abscissa. The deviation of the measured structure size is plotted on the ordinate.

What is claimed is:

1. An arrangement for improving the measurement accuracy in the nm range for optical systems, comprising:
a plurality of structures on an object;
an optical detection path and an optical illumination path;
at least one light source arranged in the optical illumination path, having at least one detector mounted in the optical detection path;
at least one optical means for changing the polarization properties and one optical means causing a beam offset and/or at least one optical means for changing the polarization property and/or at least one optical means causing a beam offset is arranged in the optical detection path and/or in the optical illumination path;
a measurement window stationarily associated with at least one structure of the plurality of structures, wherein the measurement window is oriented in a defined orientation with respect to the structures; and
means for minimizing the differences in the measurements of the structures by the detector for different orientations of the structure and the measurement window.

2. The arrangement of claim 1, wherein the optical means is a beam splitter or a mirror or a filter.

3. The arrangement of claim 1, wherein the means for minimizing the differences is a unit for removing the optical means changing the polarization property and/or causing the beam offset from the optical axis for the measurement.

4. The arrangement of claim 1, wherein the means for minimizing the differences is a further optical means changing the polarization property to compensate for a change of the polarization property caused by the optical means.

5. The arrangement of claim 2, wherein the mirrors and/or beam splitters present in the arrangement are rotated by 45° with respect to the orientation of the structures on the substrate.

6. The arrangement of claim 1, wherein the means for minimizing the differences is a unit for providing an offset to a tube lens or an objective parallel to the optical axis in a plane defined by the X-coordinate direction and the Y-coordinate direction, wherein the beam offset caused by the optical means with respect to the optical axis is compensated.

7. The arrangement of claim 6, wherein the mirrors and beam splitters present in the arrangement are rotated by 45° with respect to the orientation of the structures on the substrate.

8. The arrangement of claim 1, wherein the mirrors or beam splitters have little influence on the polarization properties, wherein the transmission of s-polarized and p-polarized light differ by less than 15%.

9. The arrangement of claim 1, wherein the optics used in the optical illumination path is designed such that the intensities of the s-polarized and p-polarized illumination light differ by less than 15%.

10. A method for improving the measurement accuracy in the nm range for an optical system, wherein a plurality of structures are provided on an object, the optical system has at least one light source arranged in an optical illumination path and least one detector mounted in an optical detection path, comprising the steps of:
providing at least one optical means for changing the polarization properties and one optical means for causing a beam offset and/or at least one optical means for changing the polarization property and/or at least one optical means for causing a beam offset in the optical detection path and/or optical illumination path;
stationarily associating a measurement window with at least one structure of the plurality of structures, and
providing means for minimizing the differences in measurements of the structures by the detector for different orientations of the at least one structure and the measurement window.

11. The method of claim 10, wherein the optical means is a beam splitter or a mirror or a filter.

12. The method of claim 10, wherein the means for minimizing the differences is a unit by which the optical means changing the polarization property and/or causing the beam offset are removed from the optical axis for the measurement.

13. The method of claim 10, wherein the means for minimizing the differences is a further optical means changing the polarization property, wherein a change of the polarization property caused by the optical means is compensated.

14. The method of claim 10, wherein the means for minimizing the differences is a further optical means changing the beam offset by which a beam offset caused by the optical means is compensated.

15. The method of claim 10, wherein the means for minimizing the differences is a further optical means changing the polarization property and an optical means changing the beam offset, wherein a change of the polarization property caused by the optical means and the beam offset are compensated.

16. The method of claim 10, wherein the means for minimizing the differences is a unit by which the objective is offset parallel to the optical axis in the plane created by the X-coordinate direction and the Y-coordinate direction so that the beam offset caused by the optical means with respect to the optical axis is compensated.

17. The method of claim 10, wherein the means for minimizing the differences is a unit by which a tube lens is offset parallel to the optical axis in the plane created in the X-coordinate direction and the Y-coordinate direction such that the beam offset caused by the optical means with respect to the optical axis is compensated.

18. An arrangement for improving the measurement accuracy in the nm range for optical systems, comprising:
a plurality of structures on an object;
an optical detection path and an optical illumination path;
at least one light source arranged in the optical illumination path, having at least one detector mounted in the optical detection path;
a beam splitter or a mirror or a filter arranged in the optical detection path and/or in the optical illumination path;
a measurement window stationarily associated with at least one structure of the plurality of structures, wherein the measurement window is oriented in a defined orientation with respect to the structures; and
means for minimizing the differences in the measurements of the structures by the detector for different orientations of the structure and the measurement window.
